(19) United States
(12) Patent Application Publication
(10) Pub. No.: US 2025/0278168 A1
(43) Pub. Date: Sep. 4, 2025

(54) ELECTRONIC DEVICE AND METHOD FOR CONTROLLING APPLICATION THAT CONTROLS HOME APPLIANCE

(71) Applicant: SAMSUNG ELECTRONICS CO., LTD., Suwon-si (KR)

(72) Inventors: Youngwook NAM, Suwon-si (KR); Seolynn PARK, Suwon-si (KR); Jaehee MOON, Suwon-si (KR); Hyungrae CHO, Suwon-si (KR); Heeyoung CHOO, Suwon-si (KR)

(73) Assignee: SAMSUNG ELECTRONICS CO., LTD., Suwon-si (KR)

(21) Appl. No.: 19/213,572

(22) Filed: May 20, 2025

Related U.S. Application Data
(63) Continuation of application No. PCT/KR2023/017453, filed on Nov. 3, 2023.

(30) Foreign Application Priority Data
Dec. 5, 2022 (KR) 10-2022-0168040

(51) Int. Cl. G06F 3/04817; G06F 3/04842

(52) U.S. Cl. CPC G06F 3/04817; G06F 3/04842

(57) ABSTRACT

A method for controlling a home appliance control application may include: displaying an icon of at least one home appliance on a screen as a pop-up; receiving a selection of a home appliance to be controlled from the at least one home appliance from a user; and maintaining or changing a size of the pop-up displayed on the screen based on the selected home appliance.

### CROSS-REFERENCE TO RELATED APPLICATIONS

This application is a continuation of International Application No. PCT/KR2023/017453, filed Nov. 3, 2023, and claims priority to Korean Application No. 10-2022-0168040, filed Dec. 5, 2022, which are incorporated herein by reference in their entireties.

### TECHNICAL FIELD

The disclosure relates to an electronic device and a method for controlling a home appliance control application.

### BACKGROUND ART

Home appliances are mainly placed in a user's home to assist with the user's housework and operate in accordance with the user's operation command while being installed in the user's home.

The user may control the home appliance by using an electronic device. Specifically, the user may control the home appliance by manipulating a user interface of the electronic device.

The user may use a home appliance control screen as a pop-up for more convenient operation, and the minimum size of the pop-up that may control the home appliance may vary depending on which home appliance the user desires to control.

### DISCLOSURE

### Technical Problem

The disclosure provides a method for controlling a home appliance control application and an electronic device that may automatically change a size of a pop-up displayed on a screen.

### Technical Solution

According to an embodiment of the disclosure, a method may include, by an electronic device: displaying an icon of at least one home appliance on a screen as a pop-up; receiving a user input to select a home appliance to be controlled from the at least one home appliance; and maintaining or changing a size of the pop-up displayed on the screen based on the selected home appliance.

The size of the pop-up displayed on the screen may be compared by the electronic device to a reference size of a pop-up of the selected home appliance to maintain or change the size of the pop-up displayed on the screen.

The size of the pop-up displayed on the screen may be changed by the electronic device to the reference size of the pop-up of the selected home appliance, based on the size of the pop-up displayed on the screen being smaller than the reference size of the pop-up of the selected home appliance.

The size of the pop-up displayed on the screen may be maintained by the electronic device, based on the size of the pop-up displayed on the screen being greater than or equal to the reference size of the pop-up of the selected home appliance.

The reference size of the pop-up of the home appliance may be determined by the electronic device based on a number of control elements of the selected home appliance and a characteristic of the home appliance.

The method may further include, by the electronic device, changing a layout of the pop-up displayed on the screen in response to the size of the pop-up displayed on the screen being changed.

The displaying of the icon of the at least one home appliance on the screen as the pop-up may include displaying the pop-up with a preset minimum size.

The method may further include, by the electronic device, displaying a notification of a change in the size of the pop-up displayed on the screen, upon changing the size of the pop-up displayed on the screen.

According to an embodiment of the disclosure, an electronic device may include: a display module configured to display information, and a processor configured to control the display module to display an icon of at least one home appliance as a pop-up, receive a user input to select a home appliance to be controlled from the at least one home appliance, and maintain or change a size of the pop-up displayed on the display module based on the selected home appliance.

The processor may be configured to compare the size of the pop-up displayed on the display module with a reference size of a pop-up of the selected home appliance to maintain or change the size of the pop-up displayed on the display module.

The processor may be configured to change the size of the pop-up displayed on the display module to the reference size of the pop-up of the selected home appliance, based on the size of the pop-up displayed on the display module being smaller than the reference size of the pop-up of the selected home appliance.

The processor may be configured to maintain the size of the pop-up displayed on the display module, based on the size of the pop-up displayed on the display module being greater than or equal to the reference size of the pop-up of the selected home appliance.

The reference size of the pop-up of the home appliance may be determined based on a number of control elements of the selected home appliance and a characteristic of the home appliance.

The processor may be configured to change a layout of the pop-up displayed on the display module in response to the size of the pop-up displayed on the display module being changed.

The processor may be configured to control the display module to display an icon of at least one home appliance as a pop-up with a preset minimum size.

The processor may be configured to control the display module to output a notification of a change in the size of the pop-up displayed on the display module, upon changing the size of the pop-up displayed on the display module.

The electronic device may further include a communication module configured to communicate with a server, and the processor may be configured to control the communication module to transmit a home appliance to be controlled to the server, the home appliance to be controlled being selected by the user, and receive the reference size of the pop-up of the selected home appliance.

### Advantageous Effects

According to an aspect of the disclosure, a method for controlling a home appliance control application and an electronic device may automatically change a size of a pop-up displayed on a screen.

### DESCRIPTION OF DRAWINGS

FIG. 1 is a diagram illustrating a home appliance control system according to an embodiment.

FIG. 2 is a diagram illustrating a screen of an application that controls a cooker.

FIG. 3 is a diagram illustrating a screen of an application that controls a television (TV).

FIG. 4 a diagram illustrating a screen of an application that controls a lighting device.

FIG. 5 is a block diagram of an electronic device according to an embodiment.

FIG. 6 is a flowchart illustrating a method for controlling a home appliance control application according to an embodiment.

FIG. 7 is a diagram illustrating home appliance icons displayed as a pop-up on a screen according to an embodiment.

FIG. 8 is a diagram illustrating a user selecting a TV to be controlled according to an embodiment.

FIG. 9 is a diagram illustrating that a size of a pop-up is changed in a case where a TV is an object to be controlled.

FIG. 10 is a diagram illustrating a user selecting a lighting device to be controlled according to an embodiment.

FIG. 11 is a diagram illustrating that a size of a pop-up is maintained in a case where a lighting device is an object to be controlled according to an embodiment.

### MODES OF THE INVENTION

Various embodiments and the terms used therein are not intended to limit the technology disclosed herein to specific forms, and the disclosure should be understood to include various modifications, equivalents, and/or alternatives to the corresponding embodiments.

It will be understood that when an element is referred to as being “connected” to another element, it may be directly or indirectly connected to the other element, where indirect connection includes “connection via a wireless communication network.”

The terms used herein is for the purpose of describing particular embodiments only and is not intended to limit the disclosure. A singular form of a noun corresponding to an item may include one or more of the items unless clearly indicated otherwise in a related context. It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

Although the terms “first”, “second”, etc. may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element.

Furthermore, the terms, such as “˜ part”, “˜ block”, “˜ member”, “˜ module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

The reference numerals used for method steps are for convenience of explanation, but not to limit an order of the steps. Thus, unless the context clearly dictates otherwise, the written order may be practiced otherwise.

Hereinafter, an operating principle and embodiments of the disclosure will now be described with reference to accompanying drawings.

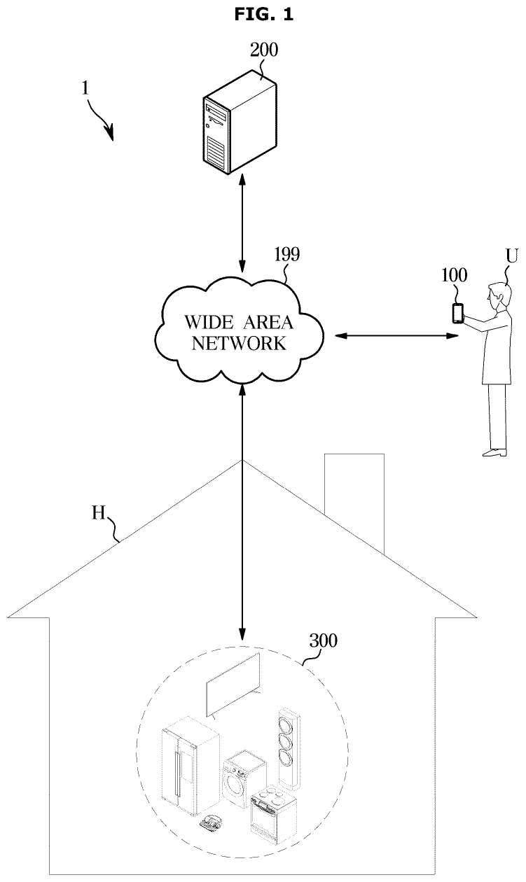

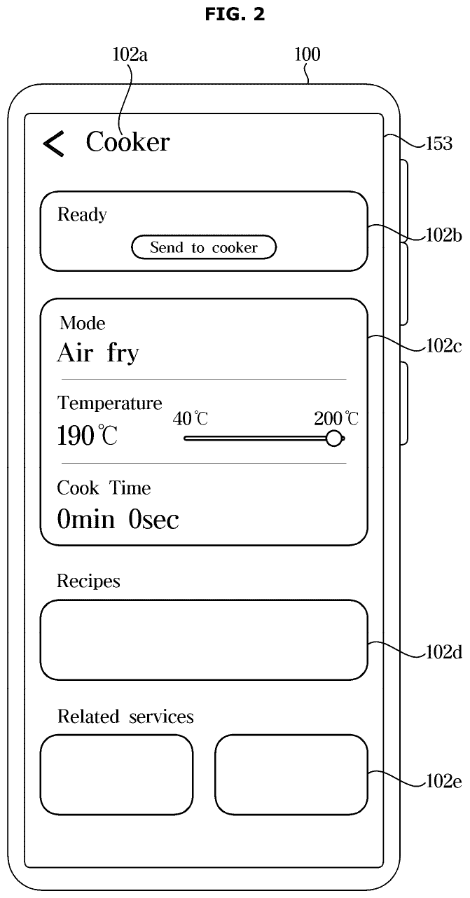

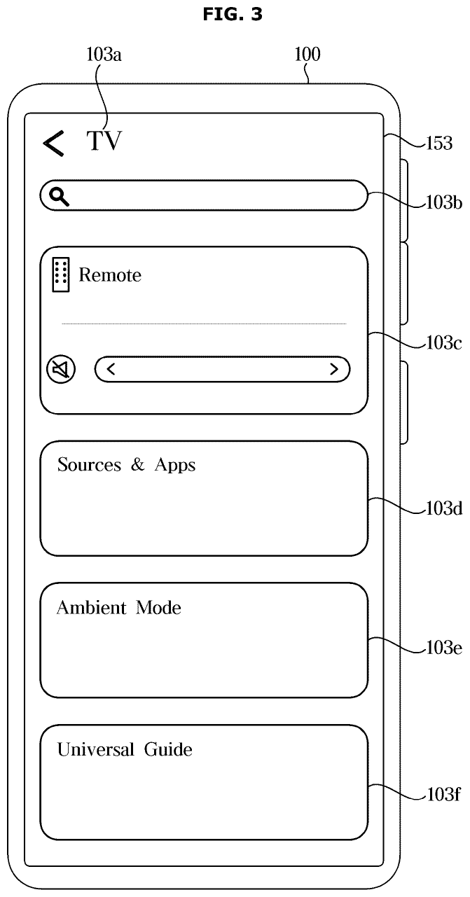

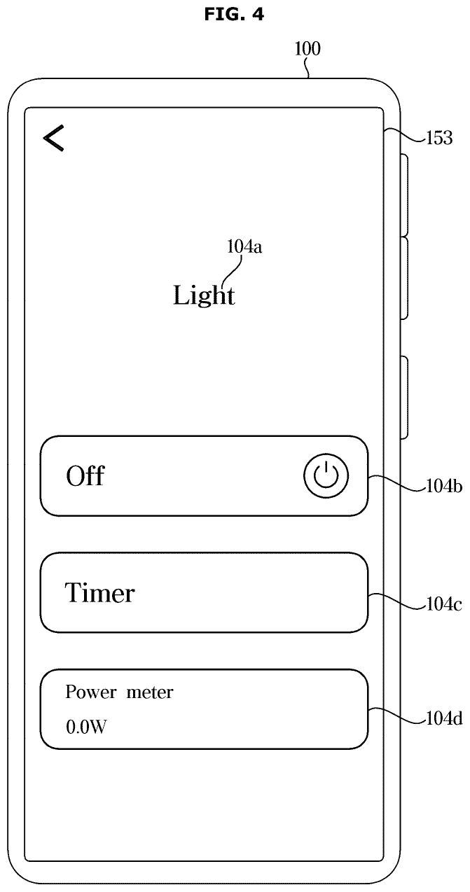

FIG. 1 is a diagram illustrating a home appliance control system according to an embodiment. FIG. 2 is a diagram illustrating a screen of an application that controls a cooker. FIG. 3 is a diagram illustrating a screen of an application that controls a television (TV). FIG. 4 a diagram illustrating a screen of an application that controls a lighting device.

Referring to FIG. 1, a home appliance control system 1 according to an embodiment may include an electronic device 100 that a user U carries, a home appliance 300 located in home H, and a server 200 that generates a command to control the home appliance 300 and a command to control the electronic device 100 based on various information received from the electronic device 100 and the home appliance 300.

The electronic device 100 that the user U carries may be a portable electronic device that may be easily carried and moved, such as a videophone, mobile phone, smart phone, wideband code division multiple access (WCDMA) user terminal device, universal mobile telecommunication service (UMTS) user terminal device, personal digital assistant (PDA), portable multimedia player (PMP), digital multimedia broadcasting (DMB) user terminal device, E-Book, laptop or tablet computer, digital camera, and the like.

The electronic device 100 may be connected to a wide area network 199 through long term evolution (LTE), LTE Advance (LTE-A), code division multiple access (CDMA), wideband CDMA (WCDMA), universal mobile telecommunications system (UMTS), wireless broadband (Wibro), or global system for mobile communications (GSM). For the communication, the electronic device 100 may include a communication module corresponding to each communication protocol.

A home appliance control application may be installed in the electronic device 100. A user may control the home appliance 300 by manipulating the home appliance control application. Hereinafter, a method for controlling the home appliance 300 through the electronic device 100 is described with reference to FIG. 2 through FIG. 4.

FIG. 2, FIG. 3, and FIG. 4 are diagrams illustrating screens of a home appliance control application according to an embodiment.

Specifically, referring to FIG. 2, upon execution of a home appliance control application, a display module 153 of the electronic device 100 may output information for controlling a cooker and various information about the cooker.

Specifically, a target 102a to be controlled by the application may be displayed at the top left. In the embodiment, the control target is a cooker, and thus “cooker” may be displayed at the top of the display.

In addition, at the top left of a window 102b, which is located below the control target, an icon that indicates a state of the cooker may be displayed. For example, an icon indicating a cooking state such as cooking ready or cooking complete may be displayed, as in READY in FIG. 2.

In addition, “send to cooker” may be displayed at the center bottom of the window 102b located below the control target. In a case where a user selects “send to cooker,” the cooker may be operated.

In addition, in a window 102c, which is located below the window 102b displaying the cooking state, etc., elements that may control the cooker may be displayed. For example, elements to control a mode (e.g., air fry) of the cooker, an operating temperature of the cooker, a cooking time, and the like may be displayed.

In a case where the user manipulates the cooker control elements, such as the mode, operating temperature, and cooking time, the electronic device 100 may transmit the user's selection to the cooker to allow the user to control the cooker through the electronic device 100.

For example, in a case where the user sets the cooker to operate for 15 minutes at 190° C. in the air fry mode and then selects the “send to cooker” icon 102b, the electronic device 100 may transmit these settings to the cooker through the communication module to allow the cooker to operate for 15 minutes at 190° C. in the air fry mode.

The information displayed on the display is not limited to the above examples, and may output various information about the cooker. Referring to FIG. 2, various types of information about the cooker and cooking may be displayed, such as recommended recipes 102d and cooker-related information 102e such as cooker filter information.

Referring to FIG. 3, upon execution of the home appliance control application, the display module 153 of the electronic device 100 may output information for controlling the television (TV) and various information about the TV.

Specifically, a target 103a to be controlled by the application may be displayed at the top left. In the embodiment, the control target is a TV, and thus “TV” may be displayed at the top of the display.

In addition, an icon for a user to input a search word may be displayed in a window 103b located below the control target. For example, as shown in the search window of FIG. 3, an icon through which the user may input a search word may be displayed.

In addition, in a window 103c located below the window 103b, which is the search window, elements that may control the TV may be displayed. For example, a remote control icon and a volume control icon may be displayed. The user may control the TV by manipulating TV control elements such as the remote control icon and the volume control icon.

In a case where the user manipulates TV control elements such as channel change or volume control, the electronic device 100 may transmit the user's selection to the TV to allow the user to control the TV through the electronic device 100.

For example, in a case where the user selects a mute icon, the electronic device 100 may transmit the user's selection through the communication module to the TV to allow the TV to be muted.

The information displayed on the display is not limited to the above examples, and may output various information about the TV. Referring to FIG. 3, various types of information about the TV may be displayed, such as information 103d about applications (apps) or devices that may be connected to the TV, TV setting mode 103e, and content recommendation information 103f.

Referring to FIG. 4, upon execution of the home appliance control application, the display module 153 of the electronic device 100 may output information for controlling a lighting device (light) and various information about the lighting device.

Specifically, a target 104a to be controlled by the application may be displayed at the top of the display. In the embodiment, the control target is a lighting device, and thus “light” may be displayed at the top of the display.

In addition, in windows 104b and 104c located below the control target, elements that may control the lighting device may be displayed. For example, elements that may control the power of the lighting device and the operating time of the lighting device may be displayed.

In a case where a user manipulates lighting device control elements such as the power of the lighting device and timer settings, the electronic device 100 may transmit the user's selection to the lighting device to allow the user to control the lighting device through the electronic device 100.

For example, in a case where the user turns off the lighting device, the electronic device 100 may transmit this to the lighting device through the communication module to allow the lighting device to be turned off.

The information displayed on the display is not limited to the above examples, and may output various information about the lighting device. Referring to FIG. 4, information about the lighting device may be displayed, such as power consumption information 104d of the lighting device.

The home appliance 300 controlled through the home appliance control application installed in the electronic device 100 may be located in home H, and may provide various outputs depending on its type.

The home appliance 300 may include an air conditioner that adjusts an indoor temperature in home H, a TV that outputs various multimedia information such as broadcast signals, a refrigerator that cools or freezes food, a cooker that cooks food, a washing machine that washes or dries laundry, a clothes treating apparatus that dries clothing or removes dust from clothes, a robot cleaner that performs cleaning in home H, a speaker that outputs sound, or a lighting device that is placed in an indoor space and emits light into the indoor space. However, the type of the home appliance 300 is not limited to the above examples and may include, without limitation, any device that performs a specific operation in home H for user convenience.

The home appliance 300 may be connected to the wide area network 199 by using a communication module of the home appliance 300, enabling communication with other electronic devices such as the server 200.

In this case, the wide area network 199 may include at least one of a telecommunication network, such as a computer network such as a local area network (LAN) or wide area network (WAN), the Internet, or a telephone network.

As described above, the server 200 may generate a command to control the home appliance 300 and a command to control the home appliance control application, based on various information received from the electronic device 100 and the home appliance 300.

In addition, according to an embodiment, the server 200 may transmit to the electronic device 100 a reference size of a pop-up for the home appliance that is selected by the user as a control target, and the server 200 may compare a current pop-up size with the reference size of the pop-up for the home appliance selected as the control target, and then transmit a command to maintain or change the pop-up size to the electronic device 100.

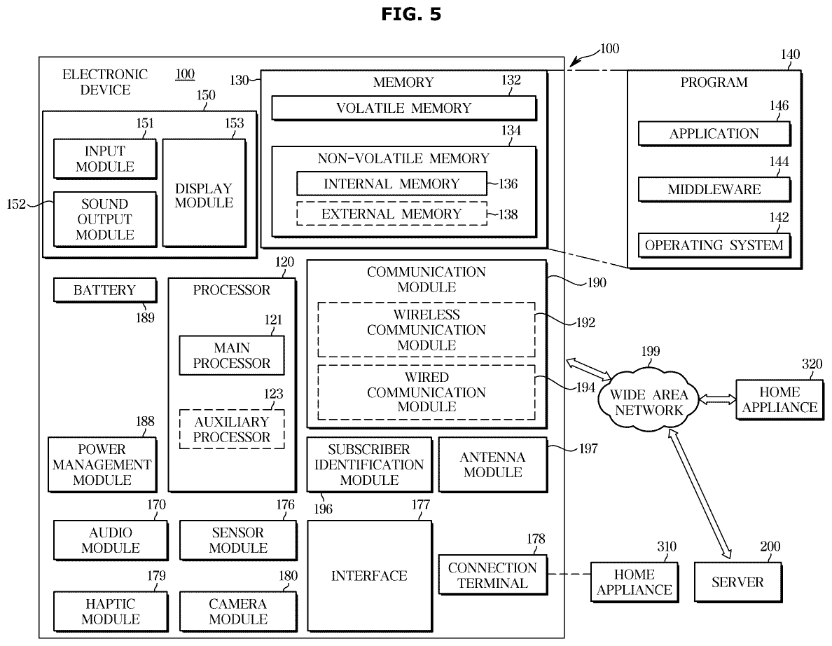

FIG. 5 is a block diagram of an electronic device according to an embodiment.

Referring to FIG. 5, the electronic device 100 may include a processor 120, a memory 130, a user interface 150, an audio module 170, a sensor module 176, an interface 177, a connection terminal 178, a haptic module 179, a camera module 180, a power management module 188, a battery 189, a communication module 190, a subscriber identification module 196, or an antenna module 197.

In some embodiments, at least one (e.g., the connection terminal 178) of the above components may be omitted, or one or more other components may be added. In some embodiments, some of the components (e.g., the sensor module 176, camera module 180, or antenna module 197) may be integrated into one component (e.g., the display module 153).

The processor 120 may, for example, execute software (e.g., a program 140) to control at least one other component (e.g., a hardware or software component) of the electronic device 100 connected to the processor 120 and may perform various data processing or operations.

According to an embodiment, as at least part of the data processing or operations, the processor 120 may store commands or data received from other components (e.g., the sensor module 176 or the communication module 190) in a volatile memory 132, may process the commands or data stored in the volatile memory 132, and may store resulting data in a non-volatile memory 134.

According to an embodiment, the processor 120 may include a main processor 121 (e.g., a central processing unit or application processor) or an auxiliary processor 123 (e.g., a graphics processing unit, neural processing unit (NPU), image signal processor, sensor hub processor, or communication processor) that may operate independently of or together with the main processor 121.

For example, in a case where the electronic device 100 includes the main processor 121 and the auxiliary processor 123, the auxiliary processor 123 may be set to use less power than the main processor 121 or be specialized for a designated function. The auxiliary processor 123 may be implemented separately from or as part of the main processor 121.

The auxiliary processor 123 may, for example, control at least a portion of the functions or states related to at least one component of the electronic device 100 (e.g., the display module 153, the sensor module 176, or the communication module 190), on behalf of the main processor 121 while the main processor 121 is inactive (e.g., sleep state) or together with the main processor 121 while the main processor 121 is active (e.g., an application running).

According to an embodiment, the auxiliary processor 123 (e.g., an image signal processor or communication processor) may be implemented as part of functionally related another component (e.g., the camera module 180 or the communication module 190). According to an embodiment, the auxiliary processor 123 (e.g., a neural processing unit) may include a hardware structure specialized for processing an artificial intelligence (AI) model. The AI model may be generated through machine learning.

The memory 130 may store various data used by at least one component (e.g., the processor 120 or the sensor module 176) of the electronic device 100. The data may include, for example, software (e.g., the program 140), and input or output data for commands related to the software. The memory 130 may include the volatile memory 132 or non-volatile memory 134.

The program 140 may be stored as software in the memory 130 and may include, for example, an operating system 142, middleware 144, or application 146.

The user interface 150 may receive input from a user, or may output various information. According to an embodiment, the user interface 150 may include an input module 151, a sound output module 152, and the display module 153.

The input module 151 may receive commands or data to be used by components (e.g., the processor 120) of the electronic device 100 from outside the electronic device 100 (e.g., from the user). The input module 151 may include, for example, a microphone, mouse, keyboard, key (e.g., a button), or digital pen (e.g., a stylus pen).

The sound output module 152 may output a sound signal to the outside of the electronic device 100. The sound output module 152 may include, for example, a speaker or a receiver. The speaker may be used for general purposes such as multimedia playback or recording playback. The receiver may be used to receive incoming calls. According to an embodiment, the receiver may be implemented separately from or as part of the speaker.

The display module 153 may visually provide information to the outside (e.g., the user) of the electronic device 100. The display module 153 may include, for example, a display, a hologram device, or a projector and a control circuit for controlling a corresponding device. According to an embodiment, the display module 153 may include a touch sensor set to detect a touch or a pressure sensor set to measure force generated by the touch.

The audio module 170 may convert sound into an electrical signal or, conversely, convert an electrical signal into sound. According to an embodiment, the audio module 170 may obtain sound through the input module 151 or, may output sound through the sound output module 152 or through an external electronic device (e.g., the home appliance 310) (e.g., a speaker or headphones) directly or wirelessly connected to the electronic device 100.

The sensor module 176 may detect an operating state (e.g., power or temperature) of the electronic device 100, or an external environmental state (e.g., the user's state) and may generate an electrical signal or data value corresponding to the detected state.

The interface 177 may support one or more designated protocols that the electronic device 100 may use to connect directly or wirelessly with an external electronic device (e.g., the home appliance 310).

The connection terminal 178 may include a connector through which the electronic device 100 may be physically connected to an external electronic device (e.g., the home appliance 310). According to an embodiment, the connection terminal 178 may include, for example, a DisplayPort connector, a high definition multimedia interface (HDMI) connector, a universal serial bus (USB) connector, a secure digital (SD) card connector, or an audio connector (e.g., a headphone connector).

The haptic module 179 may convert an electrical signal into mechanical stimulation (e.g., vibration or motion) or electrical stimulation that the user may perceive through tactile or kinesthetic sense. According to an embodiment, the haptic module 179 may include, for example, a motor, a piezoelectric element, or an electrical stimulation device.

The camera module 180 may capture still images and video. According to an embodiment, the camera module 180 may include one or more lenses, image sensors, image signal processors, or flashes.

The power management module 188 may manage power supplied to the electronic device 100. According to an embodiment, for example, the power management module 188 may be implemented as at least part of a power management integrated circuit (PMIC).

The battery 189 may supply power to at least one component of the electronic device 100. According to an embodiment, the battery 189 may include, for example, a non-rechargeable primary battery, a rechargeable secondary battery, or a fuel cell.

The communication module 190 may support the establishment of a direct (e.g., wired) or wireless communication channel between the electronic device 100 and an external electronic device (e.g., the home appliance 310, the home appliance 320, or the server 200), and may support communication through the established communication channel.

The communication module 190 may include one or more communication processors that operate independently of the processor 120 (e.g., an application processor) and support direct (e.g., wired) or wireless communication.

According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication module). The various types of communication modules may be integrated as one component (e.g., a single chip) or implemented as a plurality of separate components (e.g., multiple chips).

The wireless communication module 192 may use subscriber information (e.g., the international mobile subscriber identity (IMSI)) stored in the subscriber identification module 196 to identify or authenticate the electronic device 100 in a communication network such as a first wide area network 198 or the second wide area network 199.

The antenna module 197 may transmit signals or power to the outside (e.g., an external electronic device) or receive signals or power from the outside. According to an embodiment, the antenna module 197 may include an antenna including a radiator composed of a conductor or conductive pattern formed on a substrate (e.g., a printed circuit board (PCB)). In various embodiments, the antenna module 197 may form an mmWave antenna module.

At least a portion of the components described above may be connected to each other through a communication method (e.g., a bus, general purpose input and output (GPIO), serial peripheral interface (SPI), or mobile industry processor interface (MIPI)) among peripheral devices, and may exchange signals (e.g., commands or data) with each other.

According to an embodiment, commands or data may be transmitted or received between the electronic device 100 and the external home appliance 300 through the server 200 connected to the wide area network 199.

According to an embodiment, some or all of the operations performed in the electronic device 100 may be performed in one or more external electronic devices (310, 320, or 200) outside the electronic device 100.

For example, in a case where the electronic device 100 performs a function or service automatically or in response to a request from a user or another device, the electronic device 100 may request the one or more external electronic devices to perform at least part of the function or service, instead of or in addition to executing the function or service itself.

The one or more external electronic devices that receive the request may execute at least part of the requested function or service, or an additional function or service related to the request, and deliver the result of the execution to the electronic device 100.

The electronic device 100 may provide the result, as is or with additional processing, as at least part of the response to the request. For example, cloud computing, distributed computing, mobile edge computing (MEC), or client-server computing technology may be used.

For example, the electronic device 100 may provide an ultra-low-latency service by using distributed computing or mobile edge computing. In another embodiment, the server 200 may be an intelligent server that uses machine learning and/or neural networks.

Various embodiments and the terms used therein are not intended to limit the technical features described in the disclosure to specific embodiments, and the disclosure should be understood to include various modifications, equivalents, and/or alternatives to the corresponding embodiments. In describing of the drawings, similar reference numerals may be used for similar or related elements. The singular form of a noun corresponding to an item may include one or more of the items unless clearly indicated otherwise in a related context. In the disclosure, each of the phrases “A or B,” “at least one of A and B,” “at least one of A or B,” “A, B, or C,” “at least one of A, B, and C,” and “at least one of A, B, or C” may include any combination of all possible cases of one or more among the listed items in that phrase. Terms such as “first,” “second,” “primary,” or “secondary” may simply be used to distinguish one component from another similar component and do not limit the components in other aspects (e.g., importance or order). When an element (e.g., a first element) is referred to as being “functionally” or “communicatively” (with or without these terms) “coupled” or “connected” to another element (e.g., a second element), the first element may be connected to the second element, directly (e.g., wired), wirelessly, or through a third element.

As used in various embodiments in the disclosure, the term “module” may include a unit implemented by hardware, software, or firmware, and may be used interchangeably with terms such as logic, logic block, part, or circuit. A module may be an integrated part, or a minimum unit or a portion of a part that performs one or more functions. For example, according to an embodiment, a module may be implemented in the form of an application-specific integrated circuit (ASIC).

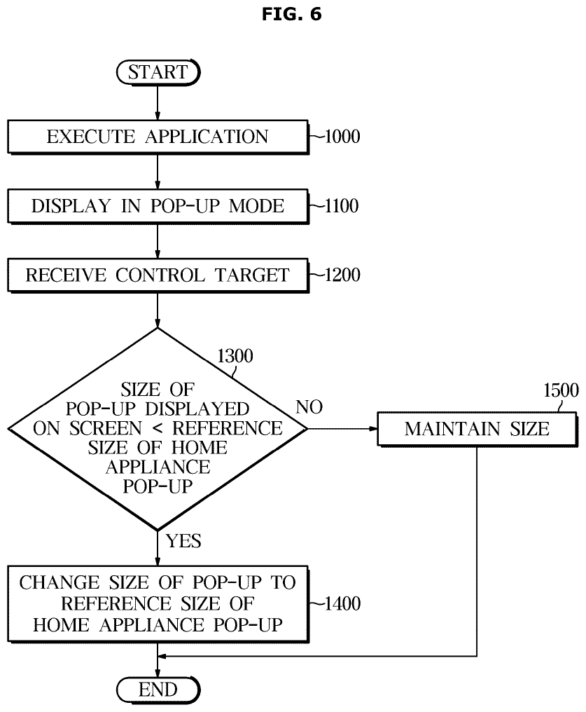

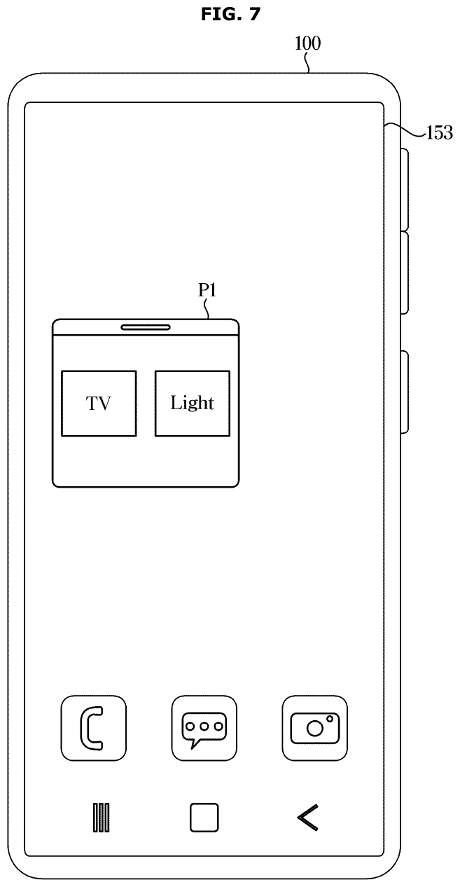

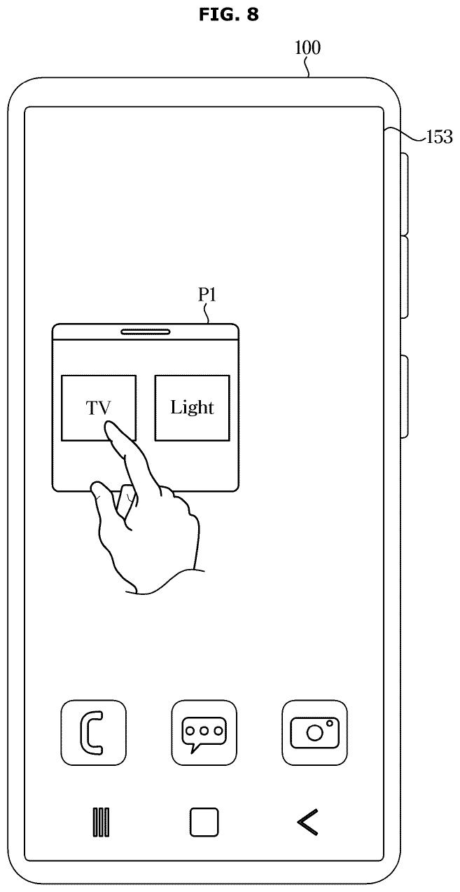

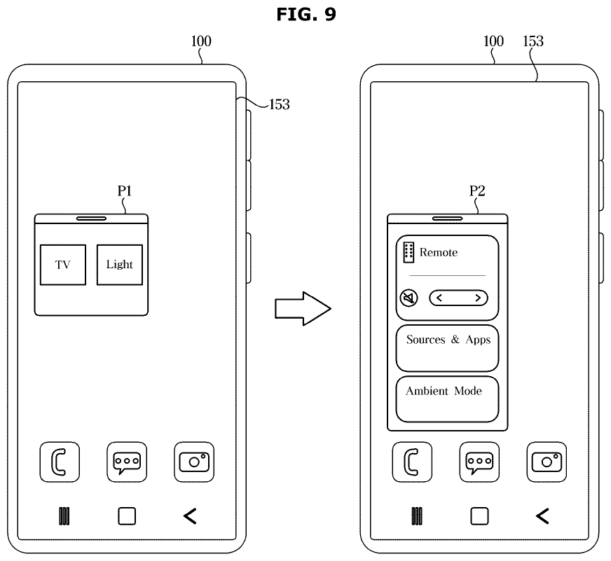

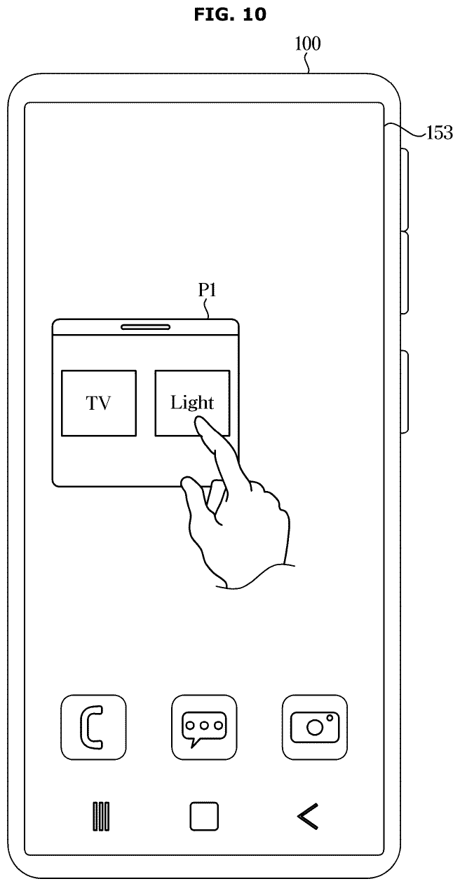

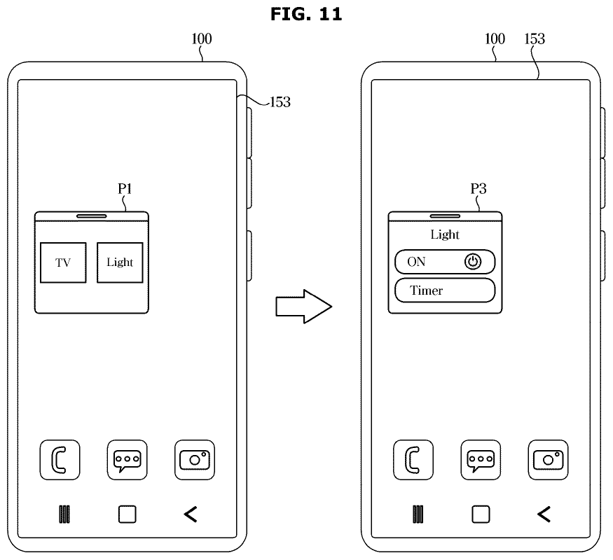

FIG. 6 is a flowchart illustrating a method for controlling a home appliance control application according to an embodiment. FIG. 7 is a diagram illustrating home appliance icons displayed as a pop-up on a screen according to an embodiment. FIG. 8 is a diagram illustrating a user selecting a TV to be controlled according to an embodiment. FIG. 9 is a diagram illustrating that a size of a pop-up is changed in a case where a TV is an object to be controlled. FIG. 10 is a diagram illustrating a user selecting a lighting device to be controlled according to an embodiment. FIG. 11 is a diagram illustrating that a size of a pop-up is maintained in a case where a lighting device is an object to be controlled according to an embodiment.

FIG. 6 is a flowchart illustrating a method for controlling a home appliance control application according to an embodiment.

Based on receiving a command to execute a home appliance control application from a user, the processor 120 may execute the home appliance control application (1000).

Upon execution of the home appliance control application, the processor 120 may control the display module 153 to display an icon of at least one home appliance as a pop-up (1100). Referring to FIG. 7, the processor 120 may control the display module 153 to display, as pop-up P1, the TV icon and the Light icon in order to induce the user to select a home appliance.

Referring to FIG. 7, icons may be displayed with the name of the control target, such as TV or Light. However, the icons are not limited to the above examples, and the form or method is not limited as long as the icons are for selecting a home appliance. For example, the icons may be pictures of the home appliances, or may be displays showing the name and state of the device.

A pop-up refers to a screen of the home appliance control application displayed in only a portion of the display module 153 rather than the entire area.

The processor 120 may display the at least one home appliance icon as a pop-up based on the input received from the user. For example, in a case where the user sets a pop-up mode by manipulating the application, the processor 120 may display the at least one home appliance icon as a pop-up.

In addition, according to an embodiment, even without user input, the processor 120 may display the at least one home appliance icon as a pop-up, upon execution of the home appliance control application.

In this instance, a size of the pop-up in which the at least one home appliance icon is displayed may be a preset size stored in the memory 130. For example, the size of the pop-up may be a size used in a previous pop-up mode stored in the memory 130, or may be a minimum size required to execute the home appliance control application (e.g., a resolution of 280×280).

The processor 120 may receive a home appliance to be controlled (control target) from the user (1200). The user may select the home appliance that is the control target from among at least one home appliance. Referring to FIG. 8, in a case where there are icons for the TV and Light, the user may select the TV icon to control the TV.

In addition, in a case where the home appliance to be controlled is selected, the processor 120 may control the communication module 190 to transmit information about the selected home appliance to the server 200.

In a case where the home appliance to be controlled is selected, the processor 120 may compare a size of the pop-up displayed by the display module 153 with a reference size of the pop-up for the selected home appliance (1300).

The reference size of the pop-up for the home appliance may be stored in the memory 130 or the server 200. For example, the reference size of the home appliance pop-up may be a minimum size for outputting control elements for controlling the home appliance on the screen.

Accordingly, the reference size of the home appliance pop-up may be determined based on the number of control elements of the home appliance to be controlled and the characteristics of the home appliance.

For example, in the case of a lighting device, because the only control elements are a power button and a timer, a reference size (e.g., a resolution of 280×280) of the lighting device pop-up may be a minimum size required to execute the home appliance control application. In the case of a cooker, because control elements of the cooker are a cooking mode, an operating temperature, a cooking time, and the like, a reference size (e.g., a resolution of 320×640) of the cooker pop-up may be larger than that of the lighting device pop-up. In the case of a TV, because control elements of the TV are a channel change and volume control and a touch area of channel change and volume control is larger than that of the lighting device, a reference size (e.g., a resolution of 284×526) of the TV pop-up may be larger than that of the lighting device pop-up but smaller than that of the cooker pop-up.

In addition, the memory 130 or the server 200 may store a layout of pop-up corresponding to the reference size of the pop-up of the home appliance. For example, depending on the reference size of the pop-up of the home appliance, the memory may store a layout of a pop-up in which an icon size is set smaller for the control elements, or a layout of a pop-up in which text is changed to images, and the like.

In a case where the size of the pop-up displayed in the display module 153 is smaller than the reference size of the pop-up of the selected home appliance (Yes in operation 1300), the processor 120 may change the size of the pop-up displayed in the display module 153 to the reference size of the pop-up of the selected home appliance (1400).

In addition, in a case where the size of the pop-up displayed in the display module 153 is greater than or equal to the reference size of the pop-up of the selected home appliance (No in operation 1300), the processor 120 may maintain the size of the pop-up displayed in the display module 153 (1500).

The comparison between the size of the pop-up displayed in the display module 153 and the reference size of the pop-up of the selected home appliance may not necessarily be performed only by the processor 120, but may also be performed by the server 200.

In a case where the server 200 performs the comparison between the size of the pop-up displayed in the display module 153 and the reference size of the pop-up of the selected home appliance, the server 200 may transmit a control command for the pop-up size to the electronic device 100 based on a comparison result, and the processor 120 may change the pop-up size based on the command.

Referring to FIG. 8, in a case where the user selects the TV as a home appliance to be controlled, the processor 120 may compare a size of pop-up P1 in which the TV icon and the Light icon are displayed with a reference size of pop-up for TV P2 (TV pop-up).

As a result of comparing the size of pop-up P1 in which the TV icon and the Light icon are displayed with the reference size of TV pop-up P2, the size of pop-up P1 is less than the reference size of TV pop-up P2, and thus the processor 120 may change the size of pop-up P1 in which the TV icon and the Light icon are displayed to the reference size of TV pop-up P2, as shown in FIG. 9.

In addition, when changing the pop-up size, the processor 120 may control the display module 153 to output a notification of the pop-up size change.

Referring to FIG. 10, in a case where the user selects the Light as a home appliance to be controlled, the processor 120 may compare the size of pop-up P1 in which the TV icon and the Light icon are displayed with a reference size of pop-up P3 for the lighting device.

As a result of comparing the size of pop-up P1 in which the TV icon and the Light icon are displayed with the reference size of lighting device pop-up P3, the size of pop-up P1 in which the TV icon and the Light icon are displayed is greater than or equal to the reference size of lighting device pop-up P3, and thus the processor 120 may maintain the size of pop-up P1 in which the TV icon and the Light icon are displayed, as shown in FIG. 11.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A method comprising, by an electronic device:
displaying an icon of at least one home appliance on a screen as a pop-up;
receiving a user input to select a home appliance to be controlled from the at least one home appliance; and
maintaining or changing a size of the pop-up displayed on the screen based on the selected home appliance.

2. The method of claim 1, wherein the size of the pop-up displayed on the screen is compared by the electronic device to a reference size of a pop-up of the selected home appliance to maintain or change the size of the pop-up displayed on the screen.

3. The method of claim 2, wherein the size of the pop-up displayed on the screen is changed by the electronic device to the reference size of the pop-up of the selected home appliance, based on the size of the pop-up displayed on the screen being smaller than the reference size of the pop-up of the selected home appliance.

4. The method of claim 2, wherein the size of the pop-up displayed on the screen is maintained by the electronic device, based on the size of the pop-up displayed on the screen being greater than or equal to the reference size of the pop-up of the selected home appliance.

5. The method of claim 2, wherein the reference size of the pop-up of the home appliance is determined by the electronic device based on a number of control elements of the selected home appliance and a characteristic of the home appliance.

6. The method of claim 2, further comprising, by the electronic device:
changing a layout of the pop-up displayed on the screen in response to the size of the pop-up displayed on the screen being changed.

7. The method of claim 1, wherein the displaying of the icon of the at least one home appliance on the screen as the pop-up includes displaying the pop-up with a preset minimum size.

8. The method of claim 1, further comprising, by the electronic device:
displaying a notification of a change in the size of the pop-up displayed on the screen, upon changing the size of the pop-up displayed on the screen.

9. An electronic device, comprising:
a display module configured to display information; and
a processor configured to:
control the display module to display an icon of at least one home appliance as a pop-up,
receive a user input to select a home appliance to be controlled from the at least one home appliance, and
maintain or change a size of the pop-up displayed on the display module based on the selected home appliance.

10. The electronic device of claim 9, wherein the processor is configured to compare the size of the pop-up displayed on the display module with a reference size of a pop-up of the selected home appliance to maintain or change the size of the pop-up displayed on the display module.

11. The electronic device of claim 10, wherein the processor is configured to change the size of the pop-up displayed on the display module to the reference size of the pop-up of the selected home appliance, based on the size of the pop-up displayed on the display module being smaller than the reference size of the pop-up of the selected home appliance.

12. The electronic device of claim 10, wherein the processor is configured to maintain the size of the pop-up displayed on the display module, based on the size of the pop-up displayed on the display module being greater than or equal to the reference size of the pop-up of the selected home appliance.

13. The electronic device of claim 10, wherein the reference size of the pop-up of the home appliance is determined based on a number of control elements of the selected home appliance and a characteristic of the home appliance.

14. The electronic device of claim 10, wherein the processor is configured to change a layout of the pop-up displayed on the display module in response to the size of the pop-up displayed on the display module being changed.

15. The electronic device of claim 9, wherein the processor is configured to control the display module to display the icon of at least one home appliance as a pop-up with a preset minimum size.
